(19) United States
(12) Patent Application Publication
(10) Pub. No.: US 2006/0072342 A1
(43) Pub. Date: Apr. 6, 2006

(54) Backlight assembly improving light efficiency and display device provided with the same

(76) Inventors: Dong-Hoon Kim, Seoul (KR); Jong-Dae Park, Seoul (KR); Jin-Sung Choi, Yongin-si (KR)

Correspondence Address: CANTOR COLBURN, LLP, 55 GRIFFIN ROAD SOUTH, BLOOMFIELD, CT, 06002, US

(21) Appl. No.: 11/202,618

(22) Filed: Aug. 11, 2005

(30) Foreign Application Priority Data
Aug. 13, 2004 (KR) 10-2004-0064024

(51) Int. Cl. F21V 7/04

(52) U.S. Cl. 362/620

(57) ABSTRACT

The present invention provides a backlight assembly improving light efficiency and a display device provided with the same. The backlight assembly according to the present invention includes a light source for emitting light, a light guiding plate for guiding the light emitted from the light source, and a prism sheet disposed on the light guiding plate, wherein the prism sheet collects light emitted from the light source. A plurality of prisms are discontinuously formed on the prism sheet in one direction, and an upper surface portion of the cross section of the respective prisms, which is taken along a width direction of the respective prisms, forms an arc.

The present application claims priority to Korean patent application No. 2004-0064024 filed on Aug. 13, 2004, and all the benefits accruing therefrom under 35 U.S.C. §119, the contents of which are herein incorporated by reference in their entirety.

### BACKGROUND OF THE INVENTION

(a) Field of the Invention

The present invention relates to a backlight assembly and a display device provided with the same, and more particularly, to a backlight assembly provided with a modified prism sheet and a display device provided with the same so as to improve light efficiency.

(b) Description of Related Art

Recently, as a result of the rapid development of semiconductor technology, the demand for small-sized and light-weight display devices having better performance has increased significantly.

Liquid crystal display (LCD) devices, generally have attributes of small size, light weight, and lower power consumption. Therefore, much attention has been paid to LCD devices as alternatives to the existing cathode ray tube (CRT). Nowadays, LCD devices are widely used for almost all information processing apparatus requiring display devices.

In a typical LCD device, a specific molecular alignment is changed into another molecular alignment by applying a voltage thereto, and then a change of optical characteristics of a liquid crystal cell, such as birefringence, optical rotary power, dichroism, optical scattering, etc., is converted into a visual change. That is, a typical LCD device is a light-receiving type of display device that displays information based on the optical modulation of liquid crystal cells.

An LCD device displays images on an LCD panel after receiving light from a backlight assembly. The light emitted from the lamp included in a backlight assembly is guided via a light guiding plate (LGP) and passes through optical sheets positioned on the LGP, and then is provided to the LCD panel with enhanced brightness. A prism sheet included in the optical sheets concentrates incident light from all directions in the direction of the LCD panel. However, when particulates intrude on the prism sheet, or the prism sheet is damaged, the light concentration efficiency decreases and thus the display quality of the LCD device is deteriorated.

In general, in an LCD device, two prism sheets are stacked in a manner such that their respective planes of polarization are at right angles to one another. As a result, although incident light from all directions can be concentrated, brightness decreases due to transmittance through the two prism sheets. Particularly, when light travels in a direction perpendicular to the direction of prism formation of the lower prism sheet, there is a possibility that the light returns to the lower prism sheet without penetrating the upper prism sheet. Accordingly, the display quality of the LCD device deteriorates due to the loss of light.

### SUMMARY OF THE INVENTION

The present invention provides a backlight assembly provided with a prism sheet capable of efficiently concentrating light.

In addition, the present invention provides a display device provided with the backlight assembly.

The backlight assembly according to the present invention includes a light source emitting light, an LGP guiding the light emitted from the light source, and a prism sheet disposed on the LGP that collects light emitted by the light source. In one embodiment, a plurality of prisms are discontinuously formed on the prism sheet in one direction. In another embodiment, an upper surface portion of the cross section of the respective prisms, which is taken along a width direction of the prism, forms an arc.

Within the plurality of prisms, a height of a first prism is different from a height of a second prism, which is located adjacent to the first prism. A ratio of the heights of the first prism and the second prism may be in the range of about 2.5 to about 4.0. The difference between the heights of the first prism and the second prism may be in the range of about 10 micrometers to about 25 micrometers.

About 85% to about 95% of the light that is incident on the first prism and the second prism is emitted from the first prism, with the remainder being emitted from the second prism.

In an exemplary embodiment, it is desirable for the height of the prism to be decreased gradually toward both ends of the prism. In another exemplary embodiment, it is also desirable for a width of the prism to be decreased gradually toward both ends of the prism. In yet another exemplary embodiment, a vertical angle of the prism is substantially a right angle.

In one exemplary embodiment, the display device includes a panel unit displaying images, and a backlight assembly supplying light to the panel unit. The backlight assembly includes a light source for emitting light, an LGP guiding the light emitted from the light source, and a prism sheet disposed on the light guiding plate. The prism sheet collects light emitted from the light source after being guided by the LGP. In one embodiment, a plurality of prisms are discontinuously formed on the prism sheet in one direction. In another embodiment, an upper surface portion of the cross section of the prisms forms an arc, when the cross section of the prism is taken along a width direction of the prism.

Within the plurality of prisms, a height of a first prism may be different from a height of a second prism, which is located adjacent to the first prism. A ratio of the heights of the first prism and second prism may be in the range of about 2.5 to about 4.0. The difference between the heights of the first prism and the second prism may be in the range of about 10 micrometers to about 25 micrometers.

About 85% to about 95% of the light that is incident on the first prism and the second prism is emitted from the first prism with the remainder being emitted from the second prism.

In an exemplary embodiment, it is desirable for the height of the prism to be decreased gradually toward both ends of the prism. It is also desirable for a width of the prism to be decreased gradually toward both ends of the prism, wherein a vertical angle of the prism is substantially a right angle. The panel unit may be an LCD panel.

### BRIEF DESCRIPTION OF THE DRAWINGS

The above and other features and advantages of the present invention will become more apparent by describing in detail exemplary embodiments thereof with reference to the attached drawings, in which:

FIG. 1 is an exemplary embodiment depicting one exploded perspective view of a display device provided with a backlight assembly according to the present invention;

FIG. 2 is an exemplary embodiment depicting an assembled perspective view of the display device shown in FIG. 1;

FIG. 3 is an exemplary embodiment of a cross-sectional view taken along Line III-III of FIG. 2;

FIG. 4 is a schematic diagram depicting an exemplary embodiment of a prism sheet included in the backlight assembly according to an embodiment of the present invention;

FIG. 5 is an exemplary embodiment of a cross-sectional view taken along Line V-V of FIG. 4; and

FIGS. 6A and 6B are graphical representations showing brightness distribution according to an experimental example of the present invention and a comparative example of the prior art, respectively.

### DETAILED DESCRIPTION OF THE INVENTION

It is to be noted that as used herein, the terms “first,” “second,” and the like do not denote any order or importance, but rather are used to distinguish one element from another, and the terms “the”, “a” and “an” do not denote a limitation of quantity, but rather denote the presence of at least one of the referenced item. Furthermore, all ranges disclosed herein are inclusive of the endpoints and independently combinable.

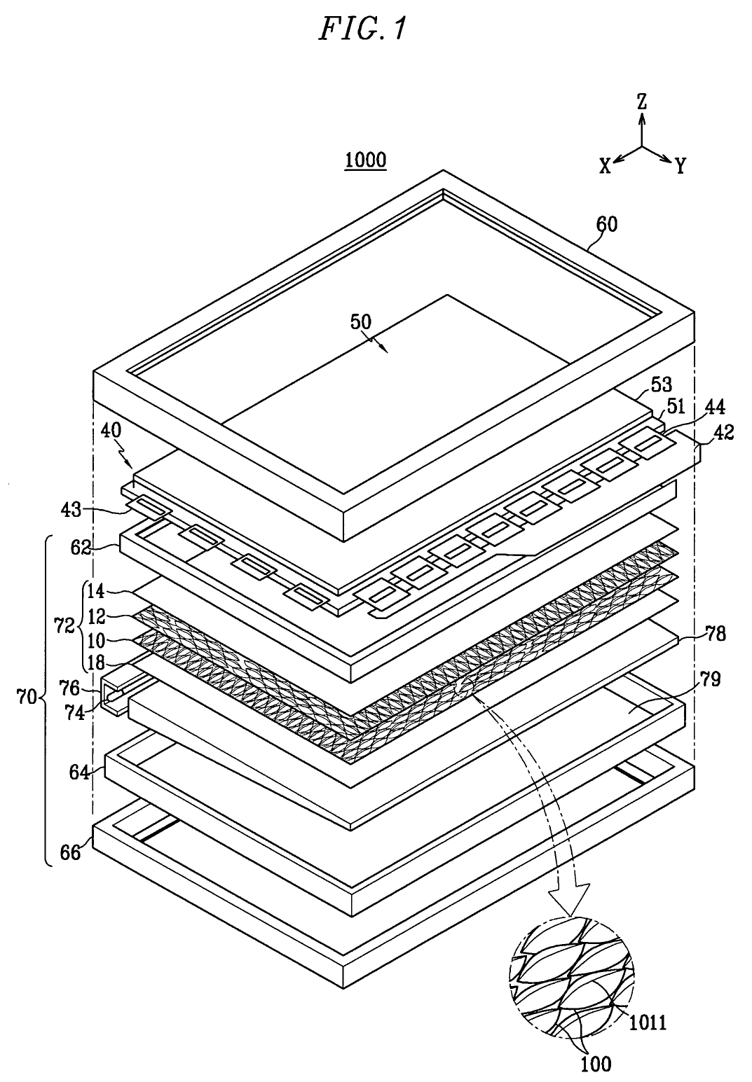

Hereinafter, the embodiments of the present invention will be described with reference to FIGS. 1 to 5. In the drawings, the thickness of layers, films, and regions are exaggerated for clarity. Like numerals refer to like elements throughout. It will be understood that when an element such as a layer, film, region or substrate is referred to as being “on” another element, it can be directly on the other element or intervening elements may also be present. Such embodiments of the present invention are to only illustrate the present invention, and not to be limited thereto.

FIG. 1 shows an exploded state of a display device 1000 provided with a backlight assembly 70 according to an embodiment of the present invention. The configuration of the display device 1000 shown in FIG. 1 is only to illustrate the present invention, and the present invention is not limited thereto. Thus, the present invention can be applied to a display device having another configuration.

The display device shown in FIG. 1 includes a backlight assembly 70 for supplying light and a panel unit 50 for displaying images by receiving to the light. A top chassis 60 fixes the panel unit 50 onto the backlight assembly 70.

The panel unit assembly 40 includes the panel unit 50, driver integrated circuit (IC) packages 43, 44, and a printed circuit board (PCB) 42. The driver IC package can be a chip on film (COF) or a tape carrier package (TCP).

Although the panel unit 50 is shown as an LCD panel in FIG. 1, this is only to illustrate the present invention, and not to limit it thereto. Therefore, it is possible to use other display panels other than the LCD panel.

The panel unit 50 includes a TFT (“thin film transistor”) panel 51 having a plurality of TFTs, a color filter panel 53 disposed on the TFT panel 51, and a material comprising liquid crystal (not shown) injected between the two panels. A polarizer (not shown) disposed on the upper part of the color filter panel 53 and below the lower part of the TFT panel 51 polarizes light provided by the backlight assembly 70.

The TFT panel 51 is a transparent glass panel on which a plurality of thin film transistors are formed in a matrix, and a plurality of data lines are connected to source terminals of the transistors, respectively, and a plurality of gate lines are connected to gate terminals of the transistors, respectively. In addition, pixel electrodes made of a conductive material such as, for example, transparent indium tin oxide (ITO) are connected to drain terminals.

When an electrical signal is applied from the PCB 42 to the data lines and the gate lines of the panel unit 50, the electrical signal is applied to the source terminals and the gate terminals of the TFTs. The TFTs can be turned ON or turned OFF depending upon the electrical signal in a manner such that the electrical signal necessary to facilitate output from a pixel is outputted through drain terminals of the TFTs.

In one embodiment, the color filter panel 53 is disposed on the TFT panel 51 to face it. The color filter panel 53 is a panel on which RGB (“Red, Green, Blue”) pixels are disposed. When light impinges upon these pixels, the interaction with the light promotes the formation of a desired color. The pixels are formed using, for example, a thin film process. The entire surface of the color filter panel 53 is coated with a common electrode made of ITO. When a thin film transistor is turned ON by applying power to the gate terminal and source terminal of the TFT, an electric field is formed between the pixel electrode and the common electrode of the color filter panel 53. This electric field varies an alignment angle of the liquid crystal molecules injected between the TFT panel 51 and the color filter panel 53. The transmittance of light is varied in accordance with the alignment angle such that desired pixel output can be obtained.

In order to control the alignment angle and the time taken to achieve such an alignment angle of the liquid crystal of the panel unit 50, a driving signal and a timing signal are applied to the gate lines and the data lines of the TFTs. Each driver IC package 43, 44 determines the application time of a data driving signal and a gate driving signal.

The PCB 42, which receives an image signal from the exterior of the panel unit 50 and applies a driving signal to the data lines and the gate lines, is connected to a driver IC package 44 attached to the panel unit 50. The PCB 42 generates data driving signals and gate driving signals for driving the display device 1000. The PCB 42 also generates a plurality of driving signals for applying such signals in a timely manner, and applies the gate driving signals and the data driving signals to the gate lines and the data lines of the panel unit 50, respectively.

The backlight assembly 70 is provided below the lower part of the panel unit assembly 40 to supply uniform light to the panel unit 50.

The upper part and the lower part of the backlight assembly 70 is securely held by an upper mold frame 62 and a lower mold frame 66, respectively. The backlight assembly 70 includes a light source 74, a light source cover 76, an LGP light guide plate 78, a reflecting sheet 79, and optical sheets 72. These elements are received in the bottom chassis 64.

The light emitted from the light source 74 enters into a side face of the LGP 78. The light source cover 76 covers the light source 74 and protects it. The light entering into the LGP 78 is uniformly diffused in the LGP 78 and is guided by the LGP 78 to the optical sheets 72. The reflecting sheet 79 is disposed below the LGP 78 and reflects light, thereby minimizing light loss. The optical sheets 72 enhance the brightness of light and supply it to the panel unit 50.

Although a lamp is shown as a light source 74 in FIG. 1, this is to only illustrate the present invention, and the present invention is not limited thereto. Therefore, light sources other than the lamp can also be used if desired.

An inverter (not shown) and a control board (not shown) are installed on the rear side of the bottom chassis 64. The inverter transforms the external power (e.g., electricity) into a constant voltage power source and supplies it to the light source. A control board is connected to the PCB 42 and converts an analog signal into a digital signal to provide it to the panel unit 50.

The optical sheets 72 include a protection sheet 14, prism sheets 10, 12, and a diffusing sheet 18. The prism sheets 10, 12 include an upper prism sheet 12 and a lower prism sheet 10. The light, which is guided by the LGP 78 and emitted through its upper face, is uniformly diffused through the diffusing sheet 18 and is gathered while passing through the prism sheets 10, 12. The upper face of the LGP 78 is facing the diffusing sheet 18. The prisms formed on the respective prism sheets 10, 12 have a three-dimensional configuration such that the light, which is diffused by the diffusion sheet 18, can be effectively gathered and can be more uniformly diffused. A protection sheet 14 is provided on the upper prism sheet 12 so as to protect the prisms included therein.

The configuration of the optical sheets 72 as shown in FIG. 1 is only to illustrate the present invention, and the present invention is not limited thereto. Accordingly, the optical sheets 72 can be modified into other desirable configurations. Particularly, as shown in FIG. 1, although the prism sheets 10, 12 include the upper prism sheet 12 and the lower prism sheet 10, this is only to illustrate the present invention, and the present invention is not limited thereto. Thus, only a single prism sheet may alternatively be used instead of the two.

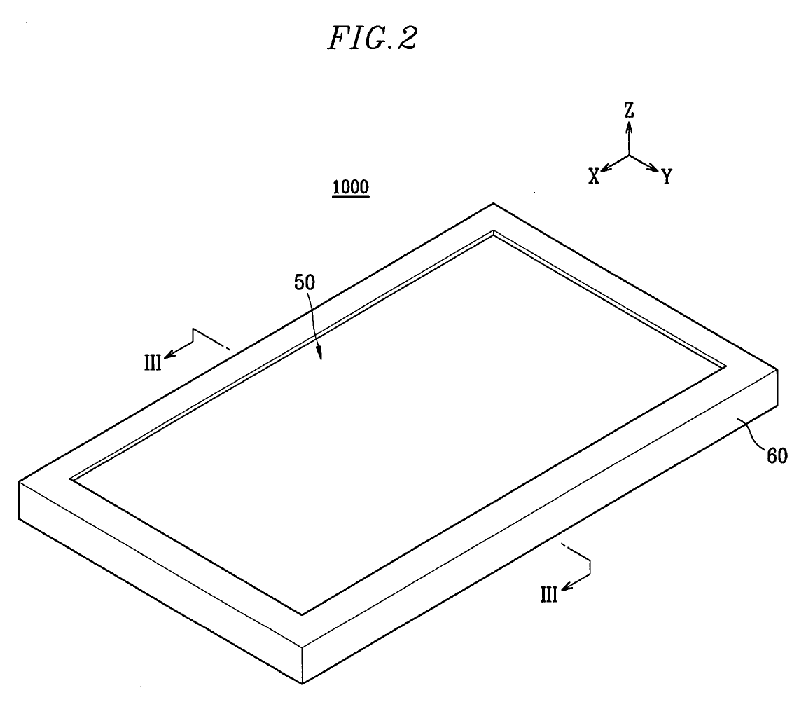

The enlarged circle depicted in the FIG. 1, depicts an enlarged view of the prisms 100 formed on the lower prism sheet 10. As shown in the enlarged circle of FIG. 1, a plurality of prisms 100 are discontinuously formed on the lower prism sheet 10 in one direction. The respective prisms 100 may have a shape such that it extends side to side along a Y direction, and end to end along an X direction. The height (z-direction) of each prism 100 decreases gradually toward both the ends thereof, as is the width of each prism 100. A plurality of prisms can also be formed on the upper prism sheet 12 in a similar manner. In such case, the prisms formed on the upper prism sheet 12 can be formed to three-dimensionally traverse the prisms of the lower prism sheet 10. In other words, the respective prisms on the upper prism sheet 12 extend side to side in the X-direction and end to end in the Y-direction. Methods of forming such prisms can easily be understood by those skilled in the art. FIG. 2 shows a display device 1000 whose elements are assembled together.

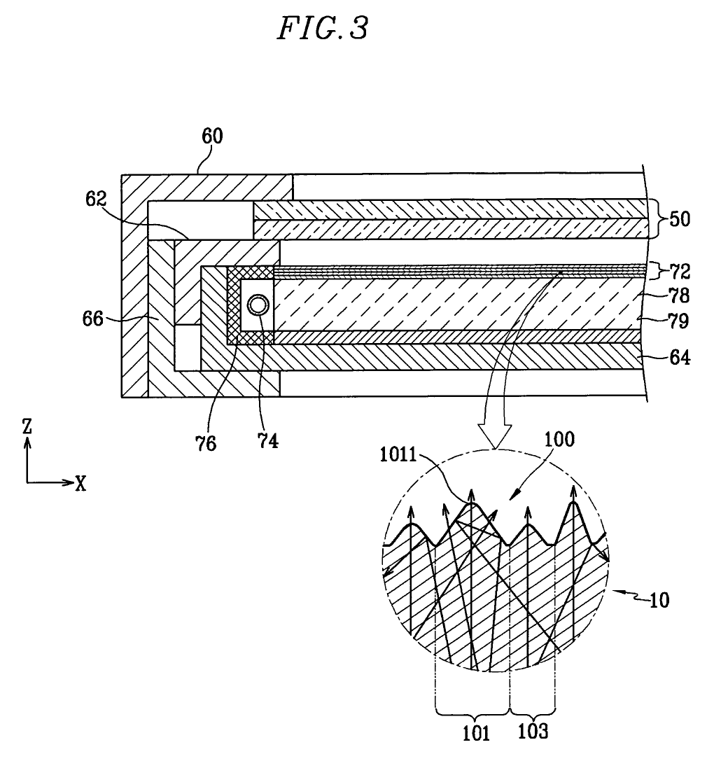

The light, after passing through the prism sheets, is supplied to the panel unit 50 in order to display desired images. That is, all light having passed through the prism sheets is made to travel in a Z direction, thereby displaying images with enhanced brightness. Hereinafter, the principle of acquiring an image with enhanced brightness will be described in detail with reference to FIG. 3.

FIG. 3 is a cross-sectional view taken along Line III-III in FIG. 2. FIG. 3 shows a state in which light is gathered and emitted by the lower prism sheet 10.

As shown in the enlarged circle depicted in FIG. 3, prisms 100 are formed on the lower prism sheet 10. As can be seen in the FIG. 3, the upper surface portion 1011 of each prism 100 forms an arc in its cross-sectional view. The cross section of the prisms 100 is formed by cutting the prism 100 along the width direction of the prism 100. As the upper surface portion 1011 of the prism 100 forms a rounded shape, loss of light can be minimized in the prism 100. Thus, as shown with arrows, light in the prism 100 is gathered at the upper surface portion 1011, thereby being smoothly emitted toward the panel unit 50. A portion of light incident on the side of the prism 100 is totally reflected and then is emitted through another prism 100.

In addition, prisms 101, 103, which are adjacent to each other, are formed to have different heights, thereby effectively gathering the light.

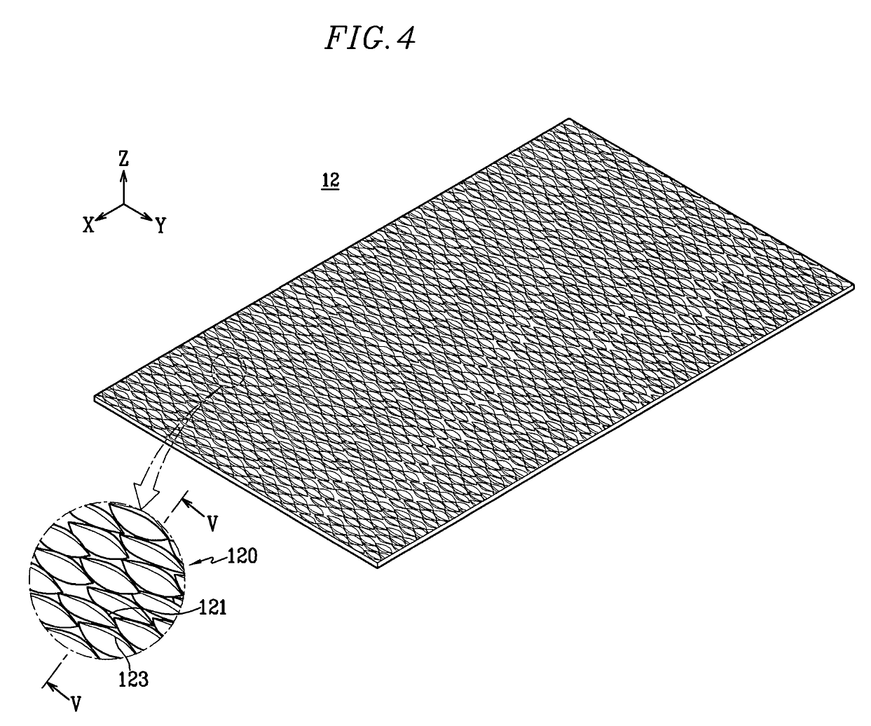

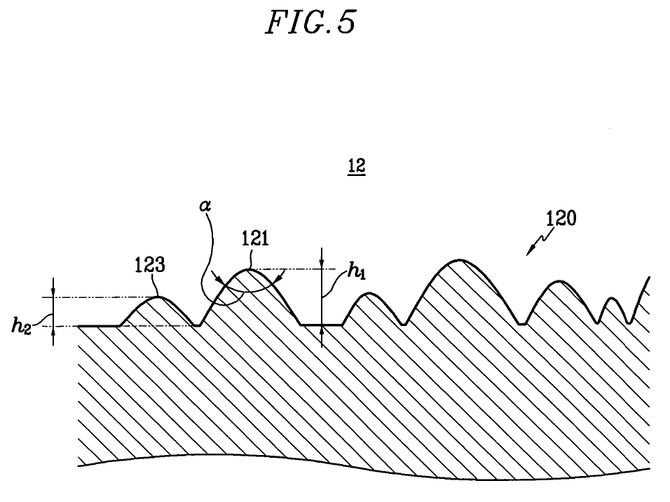

Hereinafter, the prism sheet included in the backlight assembly according to an embodiment of the present invention will be explained with reference to FIGS. 4 and 5.

FIG. 4 shows an upper prism sheet 12 shown in FIG. 1. The enlarged circle depicted in the FIG. 4, displays the configuration of prisms 120 formed on the upper prism sheet 12. The prisms 120 are analogous to the prisms 100 formed on the lower prism sheet 10 (shown in FIG. 1). However, the direction of formation of the prisms 120 in the upper prism sheet is different from the direction of formation of the prisms 100 in the lower prism sheet. In one embodiment, the direction of formation of the prisms 120 in the upper prism sheet is at substantially right angle to the direction of formation of the prisms 100 in the lower prism sheet. In another embodiment, the width of the prisms 120 in the upper prism sheet is at an angle to the width of the prisms 100 in the lower prism sheet. It is desirable for this angle to be a substantially right angle.

As shown in FIG. 4, prisms 121, 123 having different sizes are adjacent to each other. The relationship between such prisms 121, 123 will be described in detail with reference to FIG. 5.

FIG. 5 is a cross-sectional view taken along Line V-V of FIG. 4, showing an upper surface portion of cross sections of the prisms 121, 123 taken along a width direction of the prisms 121, 123. In this embodiment, a vertical angle (α) between the cutting surface of the prisms 120 and the horizontal surface of the upper prism sheet 12 substantially forms a right angle.

As shown in FIG. 5, the heights of the first prism 121 and the second prism 123 are different from each other, and the ratio of the height of the first prism to the height of the second prism is in the range of about 2.5 to about 4.0. Here, the first prism 121 and the second prism 123 are prisms which are adjacent to each other among prisms 120. If the ratio of the height h₁ of the first prism 121 to the height h₂ of the second prism 123 is less than 2.5, the appearance of the prism sheet is poor. In addition, if the ratio of the height h₁ of the first prism 121 to the height h₂ of the second prism 123 is higher than 4.0, a surface of the prism sheet 12 becomes too uneven and thus the incident light is difficult to gather.

To specify the relationship of the height h₁ of the first prism 121 and the height h₂ of the second prism 123 in detail, it is desirable that a difference between the height h₁ of the first prism 121 and the height h₂ of the second prism 123 is in the range of about 10 micrometers to about 25 micrometers. If the height difference is less than about 10 micrometers, the heights of the prisms are not substantially differentiated and the resulting appearance of the prism sheet becomes poor. On the other hand, if the height difference is more than about 25 micrometers, light is difficult to gather.

As described above, since the height h₁ of the first prism 121 and the height h₂ of the second prism 123 have a specific relationship, a range of about 85% to about 95% of light incident on the first prism 121 as well as the second prism 123 is emitted from the first prism 121 alone, while the remainder is emitted from the second prism 123. As a result, light is effectively emitted from the prism sheet 12.

The following examples, which are meant to be exemplary, not limiting, illustrate various embodiments of the present invention described herein. While these examples illustrate selected embodiments of the present invention, it is to be noted that the present invention is not limited thereto.

### EXAMPLES

The following example is used to illustrate differences between a backlight assembly comprising the prism sheet described herein and a backlight assembly with a comparative prism sheet manufactured by 3M Corporation. The prism sheet manufactured by 3M has prisms continuously formed in only one direction.

With regard to the prism sheet manufactured by 3M, the pitch of the prisms formed on the top surface is 50 micrometers and the vertical angle is 90°. Two prism sheets were used in the backlight assembly of the present invention as well as in the backlight assembly of the prior art.

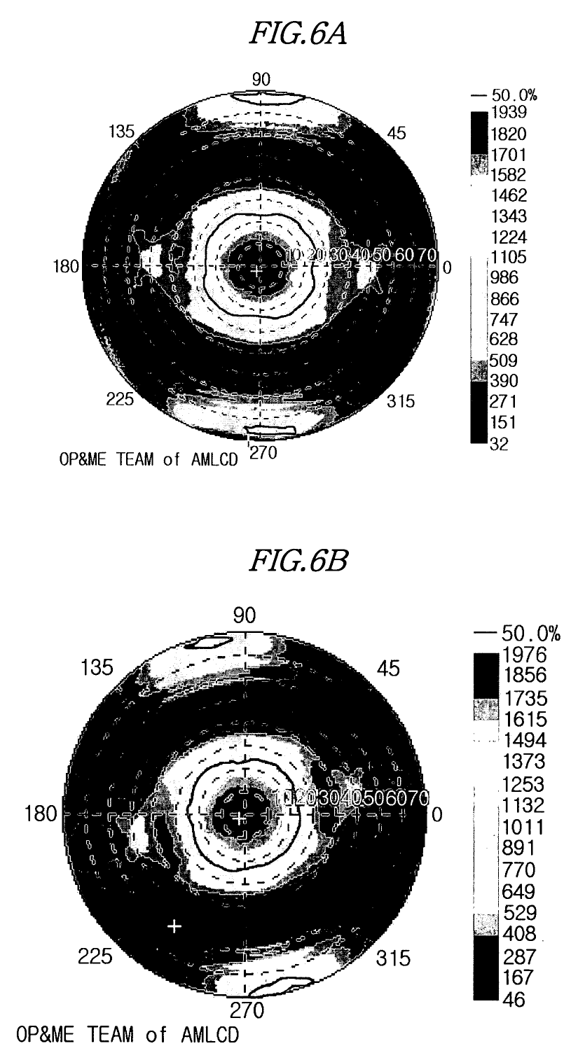

For purposes of this example, with the exception of the prism sheets, most other parts included in the backlight assembly of the present invention are similar to those used in the comparative example of the prior art. FIGS. 6A and 6B are diagrams schematically showing brightness distribution for the experimental example of the present invention and the comparative example of the prior art, respectively. In FIGS. 6A and 6B, the center part (red in a color diagram) indicates a bright part while a surrounding part (blue in a color diagram) indicates a dark part. The brightness for each color is illustrated using the bars shown on the right side of each of FIGS. 6A and 6B. An angle corresponding to a point of 50% of the maximum brightness for the brightness distribution of the entire direction, that is, a half-value width, is illustrated in Table 1. In FIGS. 6A and 6B, a half-value width affecting contrast is illustrated using a red solid line.

TABLE 1

| Half-value width | Vertical Side | | Horizontal Side | |
|---|---|---|---|---|
| Experimental Example | +22.2° | −22.5° | +25.0° | −25.3° |
| Comparative Example | +20.1° | −20.4° | +23.4° | −22.9° |

As illustrated in Table 1, when the experimental example of the present invention is compared with the comparative example of the prior art, the half-value width for vertical and horizontal sides extends by about 2° in + and − directions for the experimental example of the present invention. These results indicate that the prism sheet of the present invention promotes an increase in the area of a given brightness when compared with the comparative prism sheet manufactured by 3M. This can also be seen in the FIGS. 6A and 6B, where the area encircled by the solid line in FIG. 6A is larger than the area encircled by the solid line in FIG. 6B. As a result, the prism sheet of the present invention permits a wider light viewing angle than the comparative prism sheet manufactured by 3M.

As described above, in the backlight assembly that includes the prism sheet of the present invention, an upper surface portion of the cross section of the prism forms an arc, thereby minimizing the loss of light.

In addition, as heights of the first prism and the second prism of the prisms are different from each other, the appearance of the prism sheet can be improved.

The prism sheets of the present invention are manufactured in a manner so as to make the height of a prism decrease gradually with toward both ends of a prism, and make a width of a prism decrease gradually toward both ends of a prism, so that uneven prisms are formed and thus light is effectively collected.

In one embodiment, since the ratio of heights of the first and second prisms is in the range of about 2.5 to about 4, brightness can be greatly improved.

In another embodiment, since the height difference between the first prism and the second prism is in the range of about 10 micrometers to about 25 micrometers, brightness can be greatly improved.

In yet another embodiment, since about 85% to about 95% of light incident on the first and the second prisms is emitted only from the first prism with the remainder being emitted from the second prism, brightness is greatly improved and the light viewing angle can also be widened.

In yet another embodiment, since the vertical angle of the prism is substantially a right angle, the loss of light can be substantially minimized.

In yet another embodiment, since the display device includes the prism sheet described above, display quality is substantially improved.

While the present invention has been described above, it will be understood by those skilled in the art that various changes and modifications may be made therein without departing from the spirit and scope of the invention as defined by the appended claims.

What is claimed is:

1. A backlight assembly comprising:
a light source emitting light;
a light guiding plate guiding the light emitted from the light source; and
a prism sheet disposed on the light guiding plate, the prism sheet collecting the light emitted from the light source,
wherein a plurality of prisms are discontinuously formed on the prism sheet in one direction, and an upper surface portion of a cross section of the respective prisms, when the cross section is taken along a width direction of the respective prisms, forms an arc.

2. The backlight assembly of claim 1, wherein among the plurality of prisms, a height of a first prism is different from a height of a second prism, which is adjacent to the first prism.

3. The backlight assembly of claim 2, wherein a ratio of heights of the first prism and the second prism is in the range of about 2.5 to about 4.0.

4. The backlight assembly of claim 2, wherein a difference between heights of the first prism and the second prism is in the range of about 10 micrometers to about 25 micrometers.

5. The backlight assembly of claim 2, wherein about 85% to about 95% of light being incident on the first prism and the second prism is emitted from the first prism and the remainder of the light is emitted from the second prism.

6. The backlight assembly of claim 1, wherein a height of a prism of the prism sheet is decreased gradually toward both ends of the prism.

7. The backlight assembly of claim 6, wherein a width of a prism of the prism sheet is decreased gradually toward both ends of the prism.

8. The backlight assembly of claim 1, wherein a vertical angle of a prism of the prism sheet is substantially a right angle, wherein the vertical angle is an angle between a cutting surface of the cross section and a horizontal surface of the prism sheet.

9. The backlight assembly of claim 1, further including another prism sheet disposed adjacent to the prism sheet, the another prism sheet including a plurality of prisms discontinuously formed on the another prism, wherein a direction of formation of the prisms in the prism sheet is at substantially right angle to a direction of formation of the prisms in the another prism sheet.

10. A display device comprising:
a panel unit displaying images, and
a backlight assembly supplying light to the panel unit,
wherein the backlight assembly comprises:
a light source emitting light;
a light guiding plate guiding the light emitted from the light source; and
a prism sheet disposed on the light guiding plate, the prism sheet collecting the light emitted from the light source,
wherein a plurality of prisms are discontinuously formed on the prism sheet in one direction, and an upper surface portion of a cross section of the respective prisms forms an arc, when the cross section is taken along a width direction of the respective prisms.

11. The display device of claim 10, wherein among the plurality of prisms, a height of a first prism is different from a height of a second prism, which is adjacent to the first prism.

12. The display device of claim 11, wherein a ratio of heights of the first prism and second prism is in the range of about 2.5 to about 4.0.

13. The display device of claim 11, wherein a difference between heights of the first prism and the second prism is in the range of about 10 micrometers to about 25 micrometers.

14. The display device of claim 11, wherein about 85% to about 95% of light being incident on the first prism and the second prism is emitted from the first prism and the remainder of the light is emitted from the second prism.

15. The display device of claim 10, wherein a height of a prism of the prism sheet is decreased gradually toward both ends of the prism.

16. The display device of claim 15, wherein a width of a prism of the prism sheet is decreased gradually toward both ends of the prism.

17. The display device of claim 10, wherein a vertical angle of the prism sheet is substantially a right angle, wherein the vertical angle is an angle between a cutting surface of the cross section and a horizontal surface of the prism sheet.

18. The display device of claim 10, wherein the panel unit is a liquid crystal display panel.
